(19) United States
(12) Patent Application Publication
(10) Pub. No.: US 2014/0349267 A1
(43) Pub. Date: Nov. 27, 2014

(54) TEACHING SYSTEM INCLUDING SENSOR AIDED BALL

(71) Applicant: Battelle Memorial Institute, Columbus, OH (US)

(72) Inventor: Douglas A. Thornton, Columbus, OH (US)

(73) Assignee: Battelle Memorial Institute, Columbus, OH (US)

(21) Appl. No.: 14/285,743

(22) Filed: May 23, 2014

Related U.S. Application Data
(60) Provisional application No. 61/827,202, filed on May 24, 2013.

(51) Int. Cl. G09B 23/00

(52) U.S. Cl. CPC G09B 23/00
USPC 434/276

(57) ABSTRACT

A sensor aided ball as a tool to teach math and science. The ball may include various sensors such as inertial, pressure, magnetic, and temperature sensors. Users can run experiments and then view the results on a computer, tablet, or phone. Measurements such as acceleration, angular rate, velocity, position, heading, pressure, and temperature can be displayed. The ball may be used within an associated system or method.

### FIELD OF THE INVENTION

The invention relates to a ball with integrated sensors for measuring and collecting experimental data for use in a teaching method and system for teaching science or mathematics. The ball may be part of a system that includes an external device and can be used in a method for teaching through conducting experiments.

### BACKGROUND OF THE INVENTION

The teaching of scientific and mathematical principles has traditionally been accomplished through the use of text books and instruction by a teacher. The text book portion of study has required students to spend a substantial amount of time reading and studying written examples. Instruction by a teacher has typically included lectures on the topic with associated diagram drawings on a classroom board. When experiments have been incorporated into the classroom lessons, they generally require substantial set up time and effort. During which time the students may become disinterested or distracted. Further, the experiments often require a leap of imagination, rather than a direct illustration, of the principle being taught.

As teaching aids, sensors have proven useful in the classroom setting. Sensors can be used to collect data, which can be transferred to a computer or similar device for analysis. One drawback to using these types of sensors in a classroom setting is that the sensors are complicated and difficult to use. For example, one setup for collecting motion and pressure data for a ball involves connecting a sensor to a computer by wire, opening a special configuration file, inserting a pressure sensor needle into a ball, using masking tape to attach the sensor to the middle of a meter stick, having two students hold the ends of the meter stick above the floor, holding the ball directly below the sensor, and then finally letting the ball drop and bounce to the floor, Collecting and displaying this type of sensor data can be a useful teaching tool, however, the current systems and methods are overly complicated, requiring the use of multiple pieces of equipment.

In addition to the use of sensors in a classroom or laboratory setting, sensors have been used in sports training or coaching devices. For example, timers have been attached to baseballs for the purpose of calculating pitching speed. These timers may include a simple calculator allowing a distance to be entered so that a speed, such as miles per hour, may be calculated once the timer reports the time traveled from one point to another. As another example, sensors have been integrated into a Nerf football in order to show the angular velocity and movement through the earth's magnetic field in an application on the user's phone.

### SUMMARY OF THE INVENTION

A sensor aided ball is provided for assistance in teaching math or science. The sensor aided ball includes one or more integrated sensors that communicate with an external device that can receive, process, and display the sensed data. The sensor aided ball may include a controller and communication system so that the sensor aided ball can be programmed to collect sensor data and communicate the sensor data to another device. The operation of the sensors may be controlled by the controller based on particular sensor identifiers and triggers that may be referred to as trigger data. The trigger data for the experiments may be contained in memory associated with the ball or may be communicated to the controller in the ball from an external device. The sensor data can be graphed or otherwise displayed by the device in communication with the sensor aided ball. The sensor aided ball provides a set of sensors that can be used to perform a variety of experiments and assist in teaching math or science.

In one embodiment, an integrated sensor ball is provided with a plurality of integrated sensors, a communication system for communicating with an external device, a memory for storing sensor trigger data and a controller. The controller may be configured to monitor at least one of the plurality of integrated sensors for a trigger based on the trigger data; and change operation of at least one of the plurality of integrated sensors based upon detection of the trigger.

In another embodiment, there is provided a teaching system having a sensor system, a communication system for receiving sensor trigger data and transmitting sensor data, and a controller for controlling operation of the sensor system. The controller may be configured to monitor the sensor system for a trigger based on the sensor trigger data; and change operation of the sensor system based upon detection of the trigger. An external device may also be provided with a communication system for transmitting sensor trigger data to the integrated sensor ball and receiving sensor data from the integrated sensor ball; and a user interface for defining experiments, providing instructions to a user to manipulate the integrated sensor ball, and displaying results.

In another embodiment there is provided a method for teaching having the steps of providing an integrated sensor ball with a plurality of integrated sensors, a communication system and a controller The method may also include providing an external device with a communication system and a user interface; selecting sensor trigger data and transmitting it from the external device to the integrated sensor ball. Instructions may be provided to the user to manipulate the ball. Further steps may include monitoring at least one of the sensors fro a trigger based on the sensor trigger data and changing operation of the sensor based on detection of the trigger; transmitting sensor data from the integrated sensor ball to the external device and displaying results on the external device.

According to any of the foregoing embodiments, the sensor ball, teaching system and/or method may allow a user to select from a list of pre-defined experiments which include predefined sensors and threshold values for controlling the measurements of the sensors. Alternatively, according to any of the foregoing embodiments, the sensor ball, teaching system and/or method may allow a user to define an experiment which may include the selection of sensors and selection of the threshold values for controlling the measurements of the sensors.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1A illustrates one embodiment of a sensor aided ball;

FIG. 1B illustrates one embodiment of the sensor aided ball;

FIG. 1C illustrates one embodiment of the sensor aided ball;

FIG. 1D illustrates one embodiment of the sensor aided ball;

FIG. 2 is a schematic diagram of the ball with an accelerometer;

FIG. 3 is a flow diagram of power management system for the sensor ball;

FIG. 4 is a schematic diagram of the ball, external device and apps.

### DESCRIPTION OF THE CURRENT EMBODIMENT

A sensor aided ball can be used to teach science or math, such as various physics or calculus principles. For example, the ball may allow for exploration of kinematics, energy, friction, gravity, pendulum motion, etc., by recording measurements between selected triggers, and then displaying that information to students. Measurements such as acceleration, velocity, position, rotation rates, compass heading, pressure, magnetic field, temperature, and time may also be obtained by the ball. A student may learn about projectile motion by setting up an experiment where the ball measures acceleration, velocity, and position from the time when free fall begins, to the time when free fall ends. The student can toss the ball to another student, and the trajectory of the ball can be presented to the student. The student can compare the data to, or derive, the kinematic equations for projectile motion. The ball may allow for ‘seeing’ physics at work, rather than drawing a picture on the chalkboard. The ball and associated system may be considered a microscope for physics because it is a tool to bringing into focus concepts that were previously obscured. The ball encourages and provides an opportunity for constructive play or creative exploration after which one may come away with a better understanding of the principles at work during the play or exploration. Through this creative exploration students are afforded the opportunity to apply the scientific method rather to solve a given problem in contrast to the deductive reasoning that less creative experiment apparatus provide.

### Sensor Ball

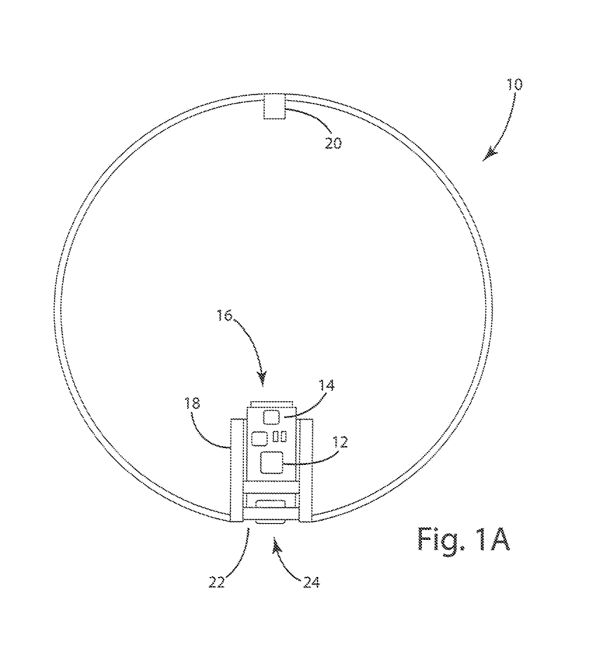

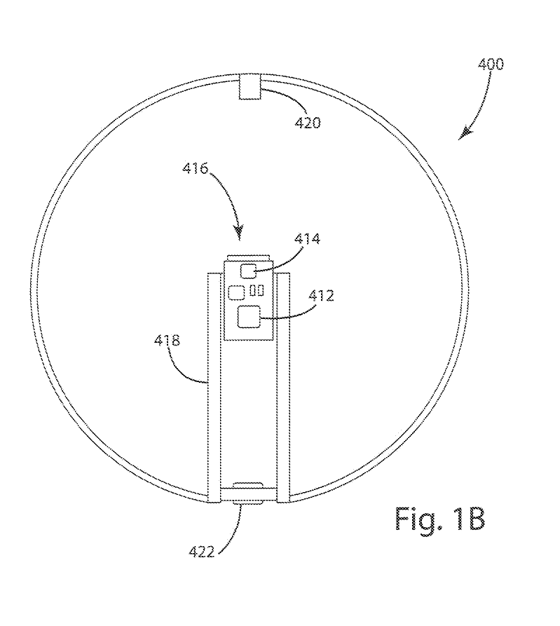

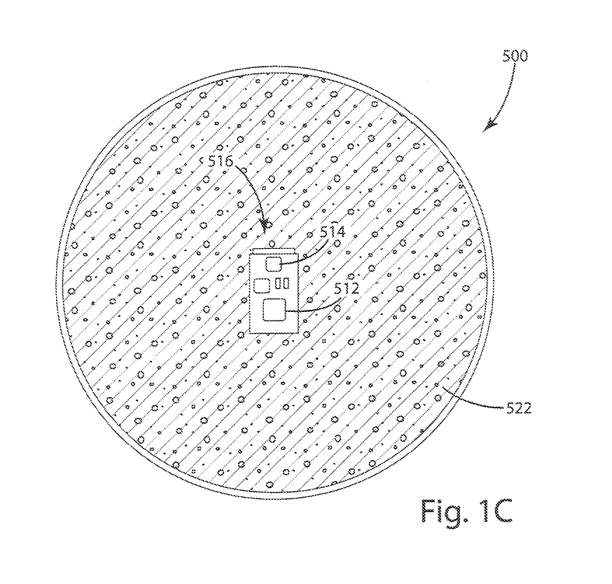

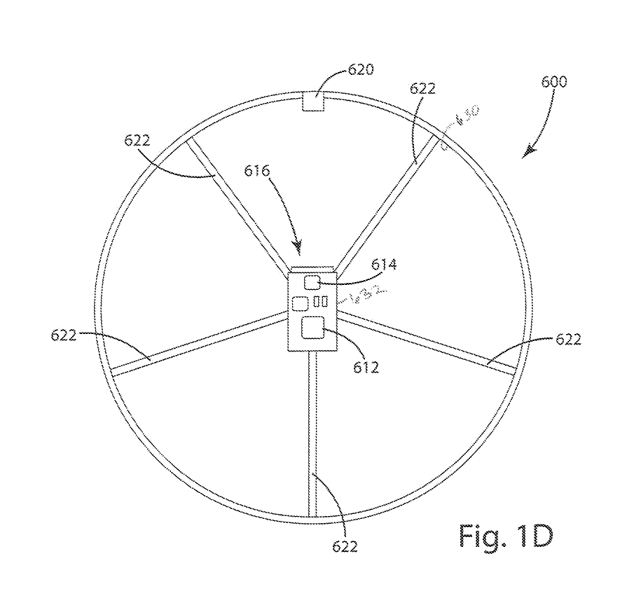

A sensor aided ball, or sensor ball, 10 is depicted in FIG. 1A. The sensor ball 10 includes a controller 12 and at least two integrated sensors 14 which may include a suite or plurality of sensors organized into a sensor system. The sensor ball 10 may include a separate battery 16 or one or more batteries integrated into the controller 12 and sensor 14. The ball 10 may include a communication system to communicate with another device. The communication system may be a stand-alone system from the controller 12 and sensors 14, or integrated with the controller 12 or sensors 14.

The controller 12, sensors 14, and other components may be attached to the inside wall of the sensor aided ball 10 or outside wall of the sensor aided ball 10. The sensors 14 can be attached in essentially any way, for example by glue or another adhesive. The components may be encased in a housing for protection and/or to assist in securely attaching them to the sensor aided ball 10, or may be housed in a carrier shaft 18, as shown in FIG. 1A, and may include sealing flanges 22 through which a USB port 24 may be provided. The ball 10 can be selectively inflatable through fill nozzle 20. If a pressure sensor is provided, the ball 10 may be inflated to a specific pressure based on output from the pressure sensor.

While the ball 10 of FIG. 1A is shown with the sensors 14 attached inside an inflated ball near the perimeter, the ball may include sensors situated closer to, or at, the center of the ball. For example, in FIGS. 1B-1D, the sensor ball 400, 500, 600 is shown with the sensors 414, 514, 614 at or near the center of the ball along with the controller 412, 512, 612 and battery 416, 516, 616. The sensors 414 in the sensor ball 400 as shown in FIG. 1B may be installed and maintained in position by an extended carrier shaft 418. The inflatable ball 400 may include fill port 420 and a cover flange 422. The sensors 514 in the sensor ball 500 as shown in FIG. 1C may be installed with a controller 512 and battery 516 in a foam core 522 within the ball 500. The sensors 614 in the sensor ball 600 as shown in FIG. 1D may be installed with one or more flexible connectors 622 extending from a wall 630 of the ball to support 632 for the sensors 614. The ball 600 may still be inflatable through fill port 620. While not shown in FIGS. 1B-1D, a USB port may be included at, or near the perimeter of the ball 400, 500, 600 and be connected to the controller 412, 512, 612 and to circuitry to perform the charging of the battery.

In one embodiment, the sensor ball is a 5″ rubber playground ball or similar inflatable sphere that hosts a small circuit board and a LiPo battery that has a 6 degree of freedom inertial measurement unit, 3 axis magnetometer, pressure sensor, and temperature sensor. In alternative embodiments, additional or fewer components may be included in the sensor ball. Further, the sensor ball may be a different shape, such as an ellipsoid.

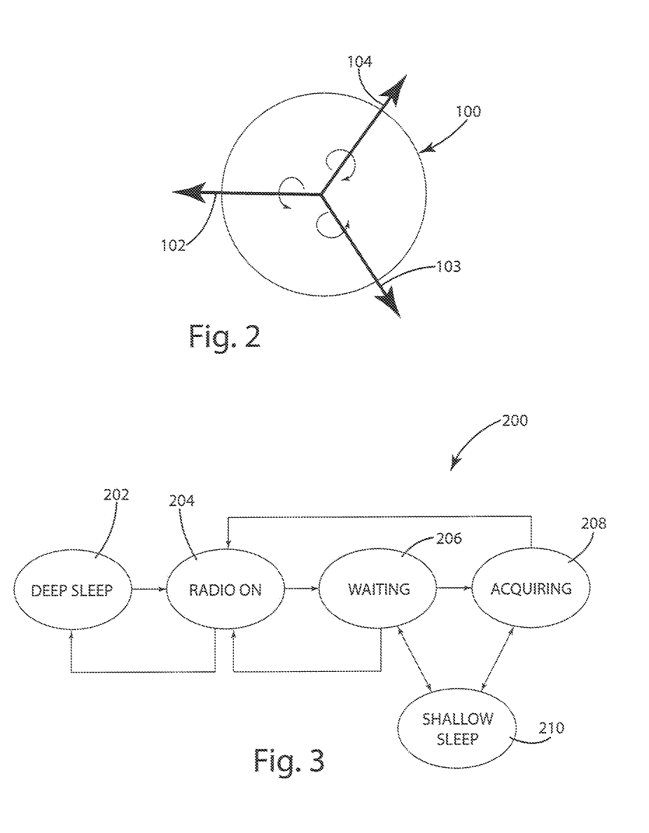

The circuit board located on the sensor aided ball can include a controller 12 and the controller 12 may include firmware and the controller may further include a memory such as a buffered or unbuffered Random Access Memory (“RAM”). In addition to storing the sensor trigger data, the RAM may also store other information such as, but not limited to, the data acquired by the sensors during sampling. The controller 12 may be programmed to allow the sensors 14 to be read and the inertial sensors can be used to place the ball's body fixed measurements into a space fixed coordinate system. The controller 12 may also be configurable to monitor at least one of a plurality of integrated sensors. The monitoring may be in response to a trigger detected by the controller, discussed further herein. Additionally, in some embodiments, the controller 12 can perform filtering to take out the drift and perform real time calibration on the sensors by using reference to absolute readings such as gravity and the earth's magnetic field. In one embodiment, the sensors can be divided into two types, the inertial sensors and the non-inertial sensors. The inertial sensors may be located in close proximity to each other, and near the center of mass of the ball. For example as depicted in FIG. 2, the sensor ball 100 may include 3 separate accelerometers or a tri-axial accelerometer to measure acceleration of the X-axis 102, Y-axis 103 and Z-axis 104. The sensor ball 100 may include filters associated with the accelerometers for allowing the small vibrations to avoid the initiation of data measurement and/or collection as discussed in the context of start and stop triggers herein below. Alternatively, the sensors may be located away from the center of mass and coordinate transformations can be performed in the firmware to translate measurements to the center of mass. The inertial sensors may be capable of making a 3 axis of angular rate measurement and 3 axis of acceleration measurement. The accelerometers can measure both static (gravity based acceleration) and dynamic acceleration (external forces applied). From these sensors, the movement and orientation of the ball through space can be tracked accurately over short periods of time (<10 s). The non-inertial sensors may include one or more magnetometers, a pressure sensor, and a temperature sensor. The magnetometers can measure magnetic field such as the magnetic field of the earth, or those induced by electric currents and permanent magnets. The magnetometer may include three axes so that the orientation of the device with respect to the magnetic field can be determined. The pressure sensor can be mounted to measure the pressure inside of the ball. A common playground ball has typically about 1-4 PSI of pressure on the inside and the sensor aided ball can be configured to also have a similar amount of pressure. If the shape of the ball changes, the volume inside the ball decreases, increasing the pressure measured by the pressure sensor. The shape change can be static, such as if the ball were placed inside a water column, or dynamic such as an impact. The temperature sensor can measure the temperature inside of the ball.

The types of sensors 14 that may be integrated with the ball 10 might be, but are not limited to, one or more accelerometers, timers, pressure sensors, temperature sensors, gyroscopes, and/or magnetometers.

### Data Measurement/Collection Triggers

The controller 12 may signal the sensors to begin measuring and collecting data and/or end the measuring and collection of data. These signals may be referred to as triggers or trigger conditions. Triggers are measured conditions that stop or start an experiment or start or stop the collection of data used to calculate a state, condition, or physical parameter relative to a particular experiment.

A trigger or trigger condition can be defined as a sensor identifier and a trigger value. The trigger condition for a given sensor may or may not be based on trigger values associated with that sensor. For example, a magnetometer may have a start or stop trigger based on an accelerometer reaching a certain trigger value. A trigger can be defined in terms of multiple sensor identifiers and trigger values. For example, a magnetometer or other sensor may have a start or top trigger based on an accelerometer reaching a certain trigger value and another sensor reaching a certain trigger value. Depending on the experiment, the definition of the trigger can be different.

Put another way, trigger data may include a specific sensor or set of sensors and a condition or set of conditions, which upon reaching cause a trigger. Based on the trigger data, the controller can initiate and/or cease data collection. These data may be stored in memory, for example, within the ball 10 or may be stored or set by a user on an external device and the data may be displayed for a user as can be the data related to the measurements taken by the sensors. The data may be displayed in a raw or processed form to the user.

Triggering data collection can have at least two purposes: (1) limiting the data displayed to only the timeframe of interest; and (2) conserving battery power. The trigger data may include a threshold value measured by a sensor 14 that can cause the controller 12 to change the frequency or sampling rate of the sensor(s) 14. The threshold value may be a specific value and may correlate to a specific sensor which may have a specific sensor identifier. The threshold value may be (a) a numerical start value or range of values; (b) a numerical stop value or range of values: (c) one or more indexed values from a table based on one or more sensor identifiers; (d) one or more indexed values based on the trigger data; (e) any of the foregoing as defined by a mathematical formula based on sensor data from one or more sensors, or (f) a combination of any of the foregoing. For example, threshold value may be a mathematical relationship between accelerometer readings in one direction that require a calculation of the difference between two readings, or a threshold value for a gravity may be calculated from readings in each of the x, y and z directions (such as requiring the square root of X²+Y²+Z² to be calculated); or a threshold value may be calculated from a magnetometer reading and accelerometer reading, etc. Also, for example, communicating data for an experiment in free fall is more efficient when only the data related to the time period of free fall is collected and displayed to the user. Providing triggers for sensor data measurement and/or collection may also conserve power and battery life by allowing for the turning off of all non-participatory sensors during the time period prior to the start trigger, and turning off all sensors upon the stop trigger. Once triggered, any sensors may turn on within a few milliseconds to measure and/or record the data requested. The start and stop triggers may be as simple as instructing the sensor(s) to measure data when a pressure spike, free fall or movement is detected, or the triggers may be more complex such as those that are calculated or combined triggers. Prior to collecting data, the sensors being triggered may operate at a lower sampling rate, when possible, to provide additional decrease in power consumption. During the time period of data collection and/or recording the sampling rate of a sensor may increase and then return to a lower sampling rate once the stop trigger is detected.

Trigger conditions can be thresholds on: measurements taken by a particular sensor, mathematical operations upon measurements, mathematical combinations of and on multiple measurements, differences of measurements with historical or average measurements, user inputs, timer expirations, or any combination thereof. Examples for these triggering thresholds are, but are not limited to: (1) for a single measurement X-axis Acceleration greater than 1.2 g's, and Pressure below 1000 mPa; (2) for a mathematical operation on a measurement would be operations such as the absolute value, a conversion to different engineering units, or scaling; (3) for mathematical combinations of measurements could be vector magnitudes of a sensor triplet, e.g. the total acceleration experienced by the ball √(x̂2+ŷ2+ẑ2), or dividing pressure by temperature which would create a trigger based upon molecules entering or leaving the volume within the ball; (4) for historical measurements provide for triggers to be defined against baseline data such as a baseline temperature and the trigger could be to stop recording data when the temperature increases by 2 degrees over the temperature when data collection started, or applying rates of change, e.g. the pressure changed faster than 0.4 mPa per second, or a threshold deviation from an average over a period of time; (5) user inputs such as those where the user explicitly stops or starts the experiment from a computer or controlling device; (6) timer expirations would be operations such as measuring for 30 seconds after the start trigger, or wait 15 seconds after receiving the experiment conditions to begin recording.

Timers may be combined with other threshold conditions to result in a trigger. For example, a start trigger may be set to initiate data measuring/collection after 2 seconds from the time a pressure measurement exceeds 1010 mPa, or with a data-buffering mechanism in place, start measuring 2 seconds before pressure exceeds 1010 mPa. The method with the data-buffering mechanism would result in sensors being read at their full rate and storing data in a circular buffer of, for example, 2 s duration until the trigger was received. This data collection method is useful for experiments where it is desired to capture the conditions preceding an event, such as the pressure changes of a ball impacted with an object.

Any of the preceding triggers may be applied together in a logical combination. For example, Boolean logic may be used consisting of AND, OR, XOR gates. Users may then construct simple combinations such as the ball rate of spin is greater than 200 degrees per second and the magnitude of acceleration is less than 0.1 g. The use of logical combinations greatly expands the number and types of available data collection schemes and, therefore, the number and types of experiments in which the ball may be used. In turn, the ball's use may be extended to teach the concepts of Boolean logic.

A more complex triggering scenario may include mathematical operations combining multiple measurements with historical measurements. An example of which would be continually estimating space fixed angles (yaw, pitch, roll) from body fixed measurements (using the result of the application of an ordinary differential equation solver) and triggering when magnitude of pitch and roll (√([(pitch)]̂2+[(roll)]̂2)) changes by a threshold value. Such a trigger would allow the ball to be spun on the axis normal to the ground and then be triggered only when a small input force was applied to the ball causing it to roll forward. This type of trigger would provide for the efficient collection and management of data related to experiments demonstrating the modification of the resulting trajectory by initial spin rate.

In the example triggers below an accelerometer that measures static acceleration is presumed, i.e. a sensor at rest experiences a 1 g force in the opposite direction of gravity in order to cancel out gravity and a sensor in free fall experiences 0 g of force. This subtlety could be hidden from students by only referencing forces that move the ball.

Example trigger conditions and corresponding experiments:
A. Dropping a ball across a magnetic field
∥Magnetism∥>average+5% and ∥Acceleration∥<0.1
B. Free fall
∥Accelerationll∥0.1
C. Magnet applied
∥Magnetism∥>average+5%
D. Ball strike
Pressure>average+25%
E. Orientation: facing North with marker up
(Yaw,Pitch,Roll)=ODE(Accelerometers,Gyroscopes,Magnetometers,time)
Yaw=North and |Pitch|<15 and |Roll|<15
F. Ball strike while spinning
∥Gyroscopes∥>100 and Pressure>average+25%
G. Acceleration not in the direction of gravity
(Yaw,Pitch,Roll)=ODE(Accelerometers,Gyroscopes,Magnetometers,time)
Spaced Fixed Accelerations=Coordinate Transform(Yaw,Pitch,Roll,Accelerometers)
∥[Space Fixed X acceleration,Space Fixed Y acceleration]∥>0.1

### Power Management

Managing power consumption of the sensor(s) can be beneficial from a power consumption standpoint and also can improve battery longevity. On the one hand, a longer on-time for the ball and its electronics is desired, on the other hand, it is desirable to keep the mass of the ball low. The former dictates a large battery size while the latter dictates a small battery size. By reducing the power consumption, the ball can be made to operate for the desired time duration while reducing battery size requirements. The battery management technique employed may selectively enable sensor(s) and the radio while leveraging sleep modes on the processor. The controller 12 as show in FIG. 1A, may be configured to monitor one or more sensors 14 for a trigger based on the trigger data and can be configured to change operation of the sensor(s) 14 upon detection of the trigger data. The changes may be, but are not limited to, changing the frequency at which measurements from the sensor are performed and/or recorded (1) from a “sleep” mode that may have a low frequency of sensor measurements to a mode of higher frequency measurement during the execution of an experiment; (2) from a mode of higher frequency measurement during an experiment to a lower frequency mode of measurement of the sensor(s) 14. The lower frequency mode may include the sensor(s) 14 being turned off. These modes can be set through the operation of a state machine. In one embodiment there can be five different power states available. A flow diagram of one embodiment of a power management system 200 of the sensor ball is shown in FIG. 3. The modes may include Deep Sleep 202, Radio On 204, Waiting for Trigger 206, Acquiring Data 208, and Shallow Sleep 210.

In one embodiment, the sensor ball can receive sensor information that includes configuration information for moving between the deep sleep 202, radio on 204, waiting 206, shallow sleep 210, and acquiring states 208. In one embodiment, the sensor information can be provided in the form of an experiment profile or experiment profile identifier. An experiment profile may include an experiment identifier, one or more sensor identifiers each associated with one of a plurality of integrated sensors, a start trigger associated with each of the sensor identifiers, a stop trigger associated with each of the sensor identifiers, a sampling rate for that sensor, and a timeout for when to end the experiment if no trigger has been experienced. In this way, an experiment profile can define when various sensors operate. Their operation can depend on certain triggers of other, different sensors. For example, the accelerometer may have a start trigger when the magnetometer reaches a certain value and a stop trigger when a gyroscope reaches a certain value. The start and stop triggers may be triggers to start or stop recording data, to start or stop powering the sensor, or to start or stop some other operation of a sensor. This experiment profile is formulated by the user interface prior to transmission to the sensor, allowing the low level details of the sensor configuration to be abstracted from the user.

During Deep Sleep 202 the lowest power movement sensor can be turned on and an interrupt can be attached to the processor. Alternatively, a timer could be used to generate an interrupt, for example in a non-movement based experiment, such as recording refrigerator temperature. During this period, the processor, the other sensors, and the radio can be in a low power sleep mode. The low power movement sensor, perhaps an accelerometer, can be set to internally sample at a low frequency, and assert an interrupt when a certain magnitude of movement is detected. The interrupt can wake the processor up and move it into the Radio On 204 state.

The Radio On 204 state listens and waits for commands from the user interface (computer, tablet or phone) or transfers data from an executed experiment. The Bluetooth or other radio protocol employed can activate and attempt to pair with a known network or if no known network is found, can enter a pairing mode where a new network can be formed. The device can stay in pairing mode for a predefined period of time and if no pairing is achieved, can return back to Deep Sleep 202. When successful pairing occurs the device can idle with the radio on and wait for commands. A command may include details to execute an experiment (the stop and start triggers) by moving to the Waiting 206 state, or the return to the Deep Sleep 202 mode via an ‘off’ indication. The other method of entry into the Radio On 204 state is when the sensor finishes acquiring and processing data from the experiment. When this transition occurs, the Radio On 204 state transmits the results to the user interface, and then waits for a command as described above. During the Radio On 204 state the sensors may be powered down to conserve batteries. The processor can use interrupt driven communications with the radio, allowing the processor to be powered down while waiting for communications.

The Waiting for Trigger 206 state processes sensor measurements to search for the start of experiment trigger. Transition to the Waiting for Trigger 206 state can cause certain sensors to turn on. Depending upon the nature of the experiment, the processor and certain sensors may remain constantly powered on and acquiring data (with short periods of low power operation between measurements) or enter the Shallow Sleep 210 mode between measurements which powers down the processors and the sensors. The former is for dynamic (such as a ball toss), short duration (seconds) experiments, while the latter is for long duration (hours) waiting for or measuring slow processes (such as a refrigerators cooling cycle). The Waiting for trigger 206 state is exited in full when the start experiment trigger is satisfied and state transitions to acquiring or the sensor has operated in this state without a trigger for a predefined period of time and ‘time-outs’ to the Radio On 204 state. Certain experiments may store data in a circular buffer while in the waiting state, allowing some data preceding the trigger condition to be captured. The circular buffer overwrites the oldest measurement when completing a new measurement.

The Acquiring Data 208 state can power on all sensors for the requested experiment and record data. Depending upon the type of experiment, the data may be stored and transmitted at completion, or transmitted throughout the experiment. While acquiring and processing the data, the processor can monitor whether the stop trigger condition has been met. When it has, the sensors are powered down and the ball transitions to the Radio On 204 state. Similar to the Wait for Trigger 206 state, the processor may enter the shallow sleep state between readings.

The Shallow Sleep 210 state allows the device to reduce power consumption while actively acquiring data. The processor sets a wake up timer and sends itself and its sensors into a sleep mode. Doing so makes long duration experiments possible by conserving battery power. Such a state needs to be cognizant of the time required to start and stabilize the sensors.

### Instructional System

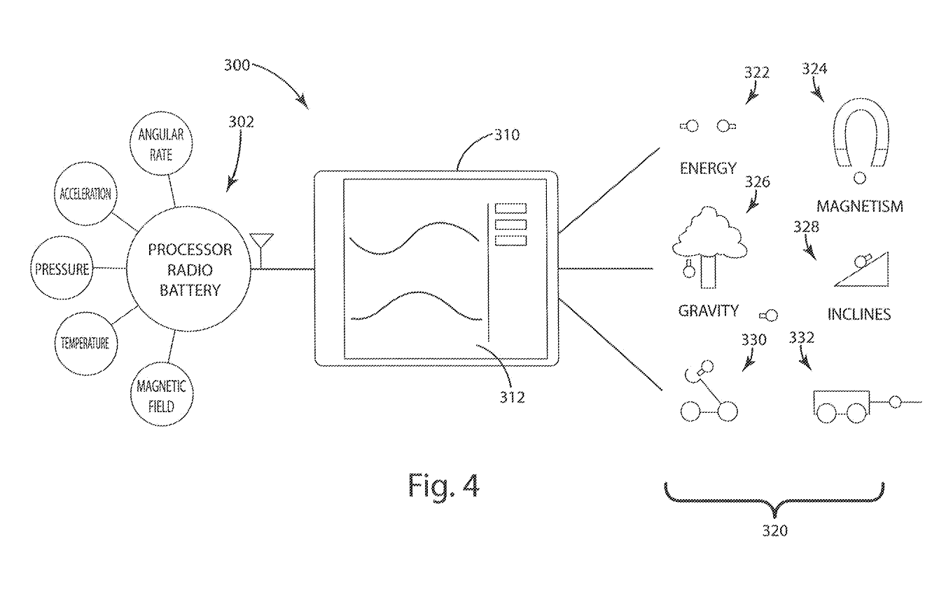

Referring to FIG. 4, the sensor ball 302 and associated sensors may be part of an instructional system 300 and may communicate with an external device 310 that includes a display or interface 312. The external device 310 may be, but is not limited to, a phone, tablet computer, desktop or personal computer, or other device. The start and stop triggers may be set by a user interfacing with the external device 310. Through the interface 312 a user may select between modes such as, for example, a “predefined experiment” mode that may allow the user to select an experiment for which the specific sensors and/or triggers for the sensors (i.e., the trigger data) are already set. The trigger data for a predefined experiment may be stored within the sensor ball 302 or may be communicated from the external device 310 to the sensor ball 302. A “user defined experiment” mode in which the user may select the specific sensors and define the sensors and threshold values of the trigger data may also be presented as an option to the user. The trigger data may then be selected by the user and communicated to the controller in the sensor ball 302 once the user enters the trigger data. In either the predefined mode or the user defined mode the user interface 312 may present the user a suite or plurality of experiment profiles. Defining the experiment in the user defined experiment mode may be by simple semantics. Several experiment profiles 320 may be associated with the external device 310. For example, such apps may include, but are not limited to, apps for experiments related to energy 322, magnetism 324, gravity 326, inclined plane 328, motion, and friction 332. A particular app 320 may initiate upon selection by a user. The app 320 may include start and stop triggers for data measurement, collection and transfer, or may prompt the user to enter the data measurement and collection triggers.

The instructional system 300 can encourage use of the scientific method over deductive reasoning in the laboratory. For example, some lessons are taught by introducing a premise such as a physical or mathematical rule, and then providing basic tools for measuring whether a situation fits the premise. This type of exercise is one in deductive reasoning and is the type of reasoning that occurs when students are given a rule for calculating gravity, a stop watch, ruler , and rock. Use of the system 300 may provide an outline of the steps of the scientific method. The steps of the method being: (1) Ask a question; (2) conduct background research; (3) construct a hypothesis; (4) conduct experiments to test the hypothesis; (5) analyze data from the experiments; (6) conclude whether the hypothesis was supported or unsupported; and (7) communicate the results. The system can provide the structure for conducting the experiments and analyzing the data as well as the other steps in the method and can add to the understanding of how evidence and experiments are viewed in the scientific community.

The defining of specific experiments may not require programming skills, but may be accomplished by dragging and dropping action words into an experiment bank, such as “Sensor(s)”, “Start (or stop measuring when” and/or “Display Vertical Velocity”, for example. Additional examples include, but are not limited to, “Start (or stop) recording when”+“free fall ends”; and/or “show”+“acceleration”+“velocity”. The user may then hold the ball, drop it, and catch it or let it hit the ground, and the acceleration and velocity may appear as a plot or set of data on the display or interface.

When the start trigger is met, the processor may instruct the sensor(s) 14 (as shown in FIG. 1A) to begin measuring its specific criteria a time intervals that are much shorter than those of sleep mode. The data measured by a specific sensor 14 may be recorded in memory associated with the controller 12. For example, the data may be directed to a buffer in memory, such as RAM, until a stop condition is met. When the stop trigger or condition is met the sensor ball 302 can transmit, i.e., over Bluetooth low energy (BLE) or some other radiofrequency interface, the sensor readings that were recorded in memory. The data may be received by a computer with a BLE receiver (Macbook air, PC+dongle, etc) or an iPad/other tablet/phone where it can be graphed or otherwise displayed. Alternatively, the communication interface may be an RS-232 interface, a USB (uniform serial bus) interface, an IrDA (infrared data association) interface. The communication interface allows for information and instructions to be loaded into the memory and allows for information stored in memory to be retrieved, or alternatively streamed in real time as the data is measured. The retrieved information may be compatible with known data management software or spreadsheets such as, but not limited to, Microsoft EXCEL®.

The app 320 may include a default selection of data to display and/or graph for a particular experiment, or the user may request a particular data set for display and graphing. The selection of data and/or graphs can include the raw data, processed space fixed data, and data numerically integrated to show velocity, heading, position and/or other characteristics of the sensor ball 302 during the experiment. Additional features may include access to an online forum that can allow user to discuss the products and experiments they are performing.

Advantages to the instructional system include added longevity and lower maintenance costs with the use of internal sensors because the sensors are protected from damage during use or from the elements by the ball. Also, by providing a suite of experiments, the system may be used as a multipurpose teaching tool that does not require the mastering of new laboratory equipment for each new experiment. The ball 302 of this system 300, including the sensors, offers a low cost option for outfitting a physics teaching laboratory as compared to current sensors or sensor kits. A set of components including, for example, a ball with an integrated circuit board (which may include a micro-controller with integrated radio), sensors, micro USB charger, a radio, battery, CCA, and passives may be purchased and assembled for relatively lower cost than currently marketed sensor kits. Additional advantages over other sensor kits is the user friendly format and time saving benefit of not requiring the switching out of sensors between experiments. Further, by (1) providing users with an opportunity for obtaining extensions through an open source, (2) free apps for tablets and/or smart phones, and/or (3) in an easy to program language, such as Python for example, the user is free to expand the capabilities of the system without being tied to software licensing issues.

### Method

The sensor ball 10, 302 may be used along with the external device 310 to perform experiments and analyze data measured by the sensors 14 during the experiment. The method may include all or some of the following steps:

providing the integrated sensor ball with the integrated sensors and a communication system for receiving trigger data from the external device, or identifying which trigger data to use if the trigger data is stored in memory within the ball. The ball may also include a controller for controlling the operation of the integrated sensors. The controller may be configured to monitor at least one of the integrated sensors for a trigger based on the trigger data and change the operation of the sensor(s) based on the detection of the trigger.

Another step may include the providing of an external device with a communication system for transmitting and receiving data to and from the sensor ball. The external device may be provided with a user interface for selecting or defining experiments, and/or providing the user with instructions to carry out the experiment which may include instructions on the manner in which to manipulate the sensor ball during the measuring of physical parameters by the sensor(s).

Additional steps of the method may include: selecting the sensor trigger for an experiment; and transmitting the sensor trigger data from the external device to the sensor ball. The step of selecting sensor trigger data for an experiment may be one of (1) selecting sensor trigger data for an experiment by defining an experiment profile via the interface of the external device; or (2) selecting a pre-defined experiment profile identifier from several available pre-defined experiment profile identifiers. If the user elects to define an experiment, the step of defining an experiment profile may include the step of creating a user defined experiment profile. In that case, the user may select one or more sensors from several available integrated sensors to be incorporated into the sensor trigger data. The user may also select one or more threshold values of measurement for each of the sensors that are selected by the user. If a pre-defined experiment is selected, each pre-defined experiment profile identifier would be associated with one of several available pre-defined experiment profiles and wherein each pre-defined experiment profile could include one or more sensor identifiers each associated with one of the integrated sensors; and/or one or more pre-defined threshold values of measurement for each of the sensor identifiers.

Instructions may also be provided to the user to manipulate the ball during the experiment. At least one of the integrated sensors may be monitored for the trigger based on the trigger data selected. Upon detection of the trigger, the method may include the operation of the sensor may change. The data from the integrated sensor ball may be transmitted to the external device and the results of the experiment may be displayed on the user interface. The results may include the raw measurements detected by the sensors or a processed version of the raw measurement.

The method may also include the step of providing one or more experiment profiles from which a user may select an experiment to conduct with the sensor ball. This step may include defining the trigger data by selecting which sensor(s), through the sensor's identifier, and which threshold values for measurements are to be used to start and stop collecting the data needed to complete the experiment.

The sensor aided ball, system and/or method can be used to teach a variety of lessons, i.e. concepts typically taught in high school physics. For example, various lessons regarding projectiles, gravity, incline planes, rotation rate and centripetal acceleration, pendulum motion, energy conversation, springs, friction, time, ideal gas law, water pressure, drag, magnetics, electricity and magnetism and be taught with one embodiment of the sensor aided ball. The sensor aided ball can be used to teach different lessons depending on the number and type of sensors included in the ball. Below, a description of how the sensor aided ball assists in the various teaching lessons is provided.

### Example Experiments

Example Experiment 1—Gravity. The ball can be dropped and measurements made at the beginning, during the fall, and at the end. The acceleration, velocity, and position can be plotted to show how the ball begins to accelerate at a constant rate when dropped. The linear relationship with velocity can be shown, followed by the squared relationship with position. Through the user interface of the external device, a user selects the experiment corresponding to gravity measurement. The device communicates instructions to the controller associated with the sensor ball and sets the accelerometer(s) in the sensor ball to initiate data collection upon detection of a start trigger, such as detecting a free fall (i.e., detecting acceleration of <0.1 g) and will continue data sample until a stop trigger is detected (i.e., acceleration of >0.1 g). The sensor ball may then be dropped from a height and let it hit the ground or catch it. When dropped the starting trigger occurs. When an acceleration above the stop magnitude is measured due to catching the ball or bounding it, the data collection ends. The user interface then displays the vector magnitude of acceleration during the test (converting body fixed ˜0 g acceleration to the space fixed ˜1 g acceleration), which will be constant, the integral of that acceleration which is velocity, and finally the integral of velocity which is position. The user can compare calculated position with how high the ball was dropped. The experiment could be extended by adding mass (e.g. taping coins) to the ball and showing how acceleration does not change because of mass. Here the 3 axis of accelerometers are used.

Example Experiment 2—Ideal Gas Law (PV=nRT). Given the sensor ball is sealed, the number of moles of gas (n) will remain constant as will the ideal constant (R). Temperature may be varied by the experimenter and changes in pressure (P) inside the ball and its volume (V) may be observed. As a data collection starting trigger, in a circular buffer mode, data collection may be set to begin 5 seconds before pressure increase, (i.e., pressure>10 mPa above baseline). Data collection may continue until a stop trigger is detected (i.e., 5 seconds of constant pressure, pressure within 10 mPa of baseline for 5 s). The student turns on the experiment and then heats the ball. The ideal gas law, PV=nRT is experienced by recording a pressure increase linearly proportional to the temperature increase. The volume of the ball remains constant as does the number of moles (n), therefore only pressure (P) and temperature (T) change. The students could cool the ball in an ice bath to generate a similar but opposite reaction. Here the pressure sensor is used, common pressure sensors contain both a pressure and temperature sensing element.

Example Experiment 3—Magnetic field's dependency on distance. The sensor aided ball can assist in teaching about magnetics. Magnetic fields can be applied to the ball to show the relationship with magnetic field and distance. Also the shape of the magnetic field can be explored. Data may be collected by a start trigger reading in a gyroscope associated with the sensor ball (i.e., a gyroscope measurement of >25 degrees/sec) and continue data collection until a stop trigger (i.e., a gyroscope reading of <25 degrees/sec) is measured. The experimental setup consists of a strong magnet mounted stationary alongside a space for the ball to roll into the magnet. The student rolls the ball at the magnet allowing it to strike the mounting and stop spinning. The ball will roll at a fairly constant speed over short distances as approaches the magnet. The resulting magnitude of the magnetic field vs time, and correspondingly space is then plotted. This plot will show how the magnetic field measured relates to the cube of distance. Here the 3 gyroscopes and 3 magnetometers are used.

Example Experiment 4—Measuring static and dynamic friction. The sensor aided ball can assist in teaching about friction. Using the ball as a spring, it becomes a force meter, and therefore friction can be explored by applying a force through the ball and measuring the pressure. The effects of static and dynamic friction can be studied. A start trigger may include beginning to collect data at 5 seconds before a pressure increase is detected. Data collection may continue until pressure returns to a baseline reading. Here the experiment requires a string to pull on the ball, and another string pull on a cart or sled. This could be accomplished by placing a non-structural band around the ball (e.g. a belt made of string) and attaching strings on opposing sides. When the student pulls on the string, it will cause the belt to compress increasing the pressure inside of the ball in proportion to the amount of force applied on the string. Correspondingly, the second string will apply a force to the cart or sled. When this force is exceeds that required to overcome static friction, the cart or sled will begin to move. The velocity graph (calculated from the accelerometers and gravity vector) will show when the cart began to move, and when it's velocity stabilized. The student can then observe how the pressure, which represents the force applied to the cart has a higher peak before the cart moves and a lower peak when it moves at constant speed, signifying the difference between static and dynamic friction. For added details, the relationship between force and pressure can be calibrated using weights for the particular setup, allowing engineering units to be calculated. Here the pressure sensor and the 3 accelerometers are used.

Example Experiment 5—Projectile motion. The sensor aided ball can assist in teaching about projectile motion by using sensors while tossing and catching the ball. The vertical and horizontal components of force experienced by the ball can be graphed and can show the effect of gravity on the vertical component but not the horizontal. The kinematic equations can be applied by the user to verify the resulting data from the sensor aided ball match the prediction from the relevant equations. A start trigger may be detecting acceleration outside of gravity, for example, setting a space fixed X acceleration and a space fixed Y acceleration of >0.1 g. Data collection in three gyroscopes, 3 accelerometers and 3 magnetometers may be collected until a stop trigger is detected. The stop trigger may be the ball indicating an impact, Δacceleration/Δt>0.1 g/s. The ball can be tossed, catapulted, or launched with initial horizontal and vertical velocities. The measurements prior to start will be used in a set of equations that make up an attitude heading reference system (AHRS) which outputs orientation measurements of yaw, pitch and roll. The AHRS uses the magnetometers to estimate yaw and correct for drift in the gyroscopes, while the accelerometers are used for correcting drift and estimating pitch and roll. During dynamic periods the gyroscopes are used to estimate the yaw, pitch and roll. Using the outputs of the AHRS the gravity vector can be known and the effect of gravity on acceleration removed. This allows the component accelerations to be transferred into space fixed coordinates and integrated. For this experiment, the vector magnitude of the X and Y coordinates will be taken as the horizontal measure and the Z coordinate (up-down) as the vertical. The student can throw the ball in an arbitrary direction and the components with gravity will be segregated from those without. The accelerations will be calculated using the AHRS angles and then integrated for velocity and position. This allows projectile motion to be studied by showing how gravity does not influence the horizontal trajectory of the ball, only the vertical.

Example Experiment 6—Inclined planes. The sensor aided ball can assist in teaching about incline planes. The ball can be placed on an inclined plane and the incline of the plane can be measured by the accelerometers sensitivity to static acceleration. When the ball is free, it accelerates down the plane at a rate defined by the angle of the plane, which can be measured and compared to the expected value by the user.

Example Experiment 7—Rotation rate and centripetal acceleration. The sensor aided ball can assist in teaching about rotation rate and centripetal acceleration. The ball can be mounted on a spinning table or swung overhead at varying radiuses and speed to describe the relationship between rotation rate, angular velocity, linear velocity, centripetal acceleration and other values.

Example Experiment 8—Pendulum motion. The sensor aided ball can assist in teaching about pendulum motion. The ball can be suspended from a string and raised to a height with the string taught. Upon release, the period of the motion and the various linear components of velocity, acceleration and position can be determined from measurements in the sensor aided ball and described, for example by displaying on a user's device in communication with the sensor aided ball.

Example Experiment 9—Energy Conservation. The sensor aided ball can assist in teaching about energy conservation. The ball can be collided with a wall to show the conservation of energy at collision (assuming ball is inflated). The ball may be impacted with another sensor aided ball of different mass to show how energy is transferred.

Example Experiment 10—Springs. The sensor aided ball can assist in teaching about springs. The ball can be used as a spring by applying force on it or through it. The pressure inside the ball effectively yields the amount of force being applied by the ball acting as a spring, which can be measured by the sensor aided ball and communicated to a user's device for display.

Example Experiment 11—Measuring time. The sensor aided ball can assist in teaching about time. The ball can be used as a stop watch measuring time between two events, either of which can be user generated.

Example Experiment 12—Water pressure. The sensor aided ball can assist in teaching about water pressure. The ball can be submersed under a water column, showing the effect of pressure on the ball by varying levels of water.

Example Experiment 13—Drag. The sensor aided ball can assist in teaching about drag. Parachutes or other drag inducing devices could be placed on the ball as it is dropped. The change in terminal velocity can be found by integrating acceleration.

Example Experiment 14—Electricity and magnetism. The sensor aided ball can assist in teaching about electricity and magnetism. The relationship between electricity and magnetism can be explored by placing the ball near an electric current. The magnetic field will induce readings on the magnetometers.

The sensor aided ball can also assist in teaching calculus because gravity, pendulums, and kinematic equations are some of the most basic calculus applications that can be used to introduce integration and differentiation.

The user interface 312 on a computer can be written in a simple language, such as python, to allow for the programming of an interface to be extended as part of a basic level computer science class. By providing students with a physical device to interface with, the programming of a computer can be made a more engaging experience, at a level of complexity below programming actual firmware, which has no inherent physical interaction.

The user interface 312 may be easy to program interface. A semantic driven user interface can use simple keywords such as start measuring when, stop measuring when. On a touch screen computer, the key words can be dragged from a word bank onto an experiment plan. The experiment plan can be shown and stored as plan text so that experiments can be shared as text, allowing easy sharing of lesson plans without downloading unknown/untrusted file types. The plotting can simplify the 3 dimensional data, while still allowing access to it if desired. For single dimension data such as gravity based experiments, the user can select to plot vertical velocity, vertical acceleration, etc. For two-dimensional tests like projectile motion, the data may align itself such that the axis coordinates are in the dominant direction of travel, and the vertical direction. A simple rotation along the xy plane may be performed to align the movement onto purely the xz plane, assuming that z is the vertical axis. The graphs selected in the experiment plan can be displayed immediately or thereabouts upon the reception of the data. If the user wanted to have additional plots, the entirety of the data gathered during the test from all sensors may be made available, so that a plot can be generated later. For sharing the results, some method of printing, screen capturing and or exporting, i.e., in tabular format, may be available.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. An integrated sensor ball for providing teaching assistance, said integrated sensor ball comprising:
a plurality of integrated sensors;
a communication system for communicating with an external device;
a memory for storing sensor trigger data;
a controller configured to:
monitor at least one of the plurality of integrated sensors for a trigger based on the trigger data; and
change operation of at least one of the plurality of integrated sensors based upon detection of the trigger.

2. The integrated sensor ball of claim 1, wherein the trigger data includes one or more sensor identifiers, each associated with one of the plurality of integrated sensors, and wherein the trigger data includes one or more threshold values of measurement for each of the sensor identifiers.

3. The integrated sensor ball of claim 2 wherein the plurality of integrated sensors includes two or more of: an accelerometer, a timer, a pressure sensor, a temperature sensor; a gyroscope, and a magnetometer.

4. The integrated sensor ball of claim 2 wherein each of the one or more threshold values of measurement are at least one of: a numerical start value or range; a numerical stop value or range; an absolute value; one or more indexed values from a table based on the one or more sensor identifiers; one or more indexed values from a table based on the trigger data; or a combination thereof.

5. The integrated sensor ball of claim 1 wherein the trigger data includes
one or more sensor identifiers associated with one of the plurality of integrated sensors;
a start trigger associated with each of the sensor identifiers; and
a stop trigger associated with each of the sensor identifiers.

6. The integrated sensor ball of claim 1 wherein the stored sensor trigger data includes a plurality of pre-defined experiment profiles, wherein each of the plurality of pre-defined experiment profiles includes:
an experiment identifier;
one or more sensor identifiers associated with one of the plurality of integrated sensors;
a start trigger associated with each of the sensor identifiers; and
a stop trigger associated with each of the sensor identifiers;
wherein the communication system for communicating with the external device receives one of a plurality of the experiment identifiers.

7. The integrated sensor ball of claim 6 wherein the start trigger and stop trigger each include:
one or more sensor identifiers, and
a threshold value associated with each of the one or more sensor identifiers.

8. The integrated sensor ball of claim 1 wherein the controller is configured to monitor for the trigger by sampling data at a sampling data rate from the at least one of the plurality of integrated sensors; wherein the controller is configured to change operation of the at least one of the plurality of integrated sensors upon detection of the trigger by changing the sampling data rate.

9. The integrated sensor ball of claim 1 wherein the controller is configured to change operation of the monitored at least one of the plurality of integrated sensors by recording sensor data after the trigger and wherein the controller is configured to change operation of at least one of the other plurality of integrated sensors by turning on the at least one of the other plurality of integrated sensors and recording sensor data after the trigger.

10. A teaching system comprising:
an integrated sensor ball having
a sensor system;
a memory for storing sensor trigger data;
a communication system for receiving sensor trigger data and transmitting sensor data;
a controller for controlling operation of the sensor system, wherein the controller is configured to
monitor the sensor system for a trigger based on the sensor trigger data; and
change operation of the sensor system based upon detection of the trigger; and
an external device having
a communication system for transmitting sensor trigger data to the integrated sensor ball and receiving sensor data from the integrated sensor ball; and
a user interface for at least one of defining an experiment and selecting a pre-defined experiment, providing instructions to a user to manipulate the integrated sensor ball, and displaying results.

11. The teaching system of claim 10, wherein the sensor system includes a plurality of integrated sensors.

12. The teaching system of claim 11, wherein the trigger data includes one or more sensor identifiers, each associated with one of the plurality of integrated sensors, and
wherein the trigger data includes one or more threshold values of measurement for each of the sensor identifiers.

13. The teaching system of claim 11 wherein the plurality of integrated sensors includes two or more of: an accelerometer, a timer, a pressure sensor, a temperature sensor; a gyroscope, and a magnetometer.

14. The teaching system of claim 11 wherein each of the one or more threshold values of measurement are at least one of: a numerical start value or range; a numerical stop value or range; an absolute value; one or more indexed values from a table based on the one or more sensor identifiers; one or more indexed values from a table based on the trigger data; or a combination thereof.

15. The teaching system of claim 11 wherein the trigger data includes
one or more sensor identifiers associated with one of the plurality of integrated sensors;
a start trigger associated with each of the sensor identifiers; and
a stop trigger associated with each of the sensor identifiers.

16. The teaching system of claim 11 wherein the sensor trigger data stored in memory includes a plurality of pre-defined experiment profiles, wherein each of the plurality of pre-defined experiment profiles includes:
an experiment identifier;
one or more sensor identifier associated with one of the plurality of integrated sensors;
a start trigger associated with each of the sensor identifiers; and
a stop trigger associated with each of the sensor identifiers;
wherein the communication system for receiving sensor trigger data receives sensor trigger data including at least one of a plurality of the experiment identifiers from the external device.

17. The teaching system of claim 16 wherein the start trigger and the stop trigger each include:
one or more sensor identifiers, and
a threshold value associated with each of the one or more sensor identifiers.

18. The teaching system of claim 17 wherein the start trigger includes at least two sensor identifiers and the threshold value is associated with a mathematical relationship between the at least two sensors.

19. The teaching system of claim 17, wherein each stop trigger includes at least two sensor identifiers and the threshold value is associated with a mathematical relationship between the at least two sensors.

20. The teaching system of claim 17, wherein the threshold value is a value defined relative to historical sensor data.

21. The teaching system of claim 20, wherein the start trigger includes a change in the historical sensor data.

22. The teaching system of claim 20, wherein the stop trigger includes a change in the historical sensor data.

23. The teaching system of 11 wherein the controller is configured to monitor for the trigger by sampling data at a sampling data rate from the at least one of the plurality of integrated sensors; wherein the controller is configured to change operation of the at least one of the plurality of integrated sensors upon detection of the trigger by changing the sampling data rate.

24. The teaching system of claim 11 wherein the controller is configured to change operation of the monitored at least one of the plurality of integrated sensors by recording sensor data after the trigger and wherein the controller is configured to change operation of at least one of the other plurality of integrated sensors by turning on the at least one of the other plurality of integrated sensors and recording sensor data after the trigger.

25. A method for teaching, the method comprising the steps of:
providing an integrated sensor ball having a plurality of integrated sensors, a communication system, and a controller;
providing an external device having a communication system and a user interface;
selecting sensor trigger data for an experiment;
transmitting the sensor trigger data from the external device to the integrated sensor ball;
providing instructions to a user to manipulate the integrated sensor ball;
monitoring at least one of the plurality of integrated sensors for a trigger based on the sensor trigger data; and
changing operation of the at least one integrated sensor based upon detection of the trigger;
transmitting sensor data from the integrated sensor ball to the external device. displaying results on the external device user interface based on the sensor data.

26. The method of claim 25 wherein the step of transmitting the sensor data occurs instantaneously after collection of the sensor data.

27. The method of claim 25, further comprising the step of storing the data into memory.

28. The method of claim 25 wherein selecting sensor trigger data for an experiment includes selecting a pre-defined experiment profile identifier from a plurality of pre-defined experiment profile identifiers, wherein each pre-defined experiment profile identifier is associated with one of a plurality of pre-defined experiment profiles and wherein each pre-defined experiment profile includes:
one or more sensor identifiers, each associated with one of the plurality of integrated sensors, and
one or more predefined threshold values of measurement for each of the sensor identifiers.

29. The method of claim 25 wherein selecting sensor trigger data for an experiment includes defining an experiment profile via the external device user interface.

30. The method of claim 29 defining the experiment profile includes:
selecting one or more sensor identifiers each associated with one of the plurality of integrated sensors;
selecting a start trigger and stop trigger for each of the selected sensor identifiers;
wherein each start trigger and each stop trigger includes
one or more sensor identifiers, and
a threshold value associated with each of the one or more sensor identifiers.

31. The method of claim 30, wherein each start trigger includes at least two sensor identifiers and the threshold value is associated with a mathematical relationship between the at least two sensors.

32. The method of claim 30, wherein each stop trigger includes at least two sensor identifiers and the threshold value is associated with a mathematical relationship between the at least two sensors.
